(19) United States
(12) Patent Application Publication
(10) Pub. No.: US 2015/0289245 A1
(43) Pub. Date: Oct. 8, 2015

(54) WIRELESS COMMUNICATION APPARATUS AND WIRELESS BASE STATION APPARATUS

(71) Applicant: SHARP KABUSHIKI KAISHA, Osaka-shi, Osaka (JP)

(72) Inventors: Hideo Namba, Osaka-shi (JP); Minoru Kubota, Osaka-shi (JP)

(73) Assignee: SHARP KABUSHIKI KAISHA, Osaka-shi, Osaka (JP)

(21) Appl. No.: 14/436,813

(22) PCT Filed: Oct. 7, 2013
(86) PCT No.: PCT/JP2013/077205

§ 371 Date: Apr. 17, 2015

(30) Foreign Application Priority Data
Oct. 19, 2012 (JP) 2012-231917

(51) Int. Cl. H04W 72/04; H04W 74/00; H04W 28/04

(52) U.S. Cl. CPC H04W 72/0406; H04W 28/04; H04W 74/004; H04W 88/08

(57) ABSTRACT

There is provided a first wireless communication apparatus that is used in a wireless communication system in which plural wireless communication apparatuses simultaneously transmit data to a wireless base station apparatus, the first wireless communication apparatus including a transmission timing control unit that performs control such that a channel estimation signal is not transmitted in a case where a second wireless communication apparatus transmits the channel estimation signal. This enables reduction in errors in channel state information.

### TECHNICAL FIELD

The present invention relates to a wireless communication technology.

### BACKGROUND ART

Devices in which a wireless communication function is installed have been increasing as introduction of wireless network technologies progresses. Particularly, devices in which a wireless LAN function is installed such as IEEE 802.11 have been increasing, and introduction thereof to digital television receivers, cellular phones, and so forth has been progressing.

A wireless LAN of the IEEE 802.11 scheme uses an access scheme by carrier sense multiple access/collision avoidance (CSMA/CA), in which carrier sense is performed prior to transmission and random back-off is thereafter used to avoid collision. Further, to solve the hidden node problem, exchange of request to send (RTS; also referred to as transmission request) and clear to send (CTS; also referred to as transmission permission) is performed. Detection of the hidden nodes by the RTS-CTS exchange may be referred to as “virtual carrier sense”.

There is a multi user-multi input multi output (MU-MIMO) technology as a technology that improves use efficiency of radio waves under an environment where multiple wireless communication devices are present. In a usual MIMO technology, a pair of communication apparatuses uses plural transmit antennas and plural receive antennas to increase the communication capacity by spatial multiplexing. However, the MU-MIMO technology is a technology in which a communicator that includes plural antennas simultaneously communicates with plural communication devices by performing spatial multiplexing in communication with the plural communication devices that include one or more antennas and the communication capacity is thereby increased. It is possible to apply the MU-MIMO to transmission from an individual communication apparatus to a base station apparatus. This enables a significant improvement in communication efficiency, compared to a case where communication between a pair of communication apparatuses in one time is performed, when transmission is performed from plural transmission apparatuses to a base station.

In the following NPL 1, only a pilot symbol is transmitted by TDM based on control by the base station apparatus.

### CITATION LIST

### Non Patent Literature

NPL 1: An efficient uplink multiuser MIMO protocol in IEEE 802.11 WLANs, PIMRC 2009, IEEE, September 2009.

### SUMMARY OF INVENTION

### Technical Problem

In a case where communication by MU-MIMO is performed, plural communication apparatuses almost simultaneously provide transmission requests, and the transmission requests asynchronously occur, a circumstance occurs where transmission start times from the plural communication apparatuses are mutually slightly different. In order to perform communication by MU-MIMO, it is necessary to obtain channel state information between the communication apparatuses that perform communication. A general method of obtaining the channel state information is a method of transmitting a known signal and calculating the channel state information based on a signal that is actually received. A method of simultaneously obtaining the channel state information between the plural communication apparatuses may be a method in which a orthogonal code is used as a known signal, a different code is simultaneously transmitted from each of the communication devices, and despreading is performed on the receiving side. However, it is difficult to allocate different codes to all the communication apparatuses because the number of orthogonal codes is limited. Further, orthogonality between the codes does not hold in a case where simultaneous transmission may not be performed among transmission apparatuses. Further, interference with communication data or the like other than the known signal occurs. This results in a problem that errors in obtained channel state information increase.

An object of the present invention is to reduce errors in channel state information.

### Solution to Problem

In the present invention, control is performed so that transmission timings of channel estimation codes (preambles) that are transmitted from plural communication apparatuses are mutually different.

One aspect of the present invention provides a first wireless communication apparatus that is used in a wireless communication system in which plural wireless communication apparatuses simultaneously transmit data to a wireless base station apparatus, the first wireless communication apparatus including a transmission timing control unit that performs control such that a channel estimation signal is not transmitted in a case where a second wireless communication apparatus transmits the channel estimation signal.

The transmission timing control unit may perform control such that transmission of the channel estimation signal is performed in a case where the second wireless communication apparatus transmits data following transmission of the channel estimation signal.

The present invention provides a wireless base station apparatus that is used in a wireless communication system in which plural wireless communication apparatuses simultaneously transmit data to a wireless base station apparatus, the wireless base station apparatus including a control unit that performs control such that at least two of the plural wireless communication apparatuses that simultaneously transmit data do not simultaneously transmit a channel estimation signal.

After transmission of data starts after a first wireless communication apparatus transmits the channel estimation signal, one of the wireless communication apparatuses that are different from the first wireless communication apparatus may be caused to start transmission of the channel estimation signal.

Further, the wireless communication apparatuses may be split into plural groups, and group allocation may be performed such that the number of the wireless communication apparatuses that are included in the group does not exceed the number of data that the wireless base station apparatus is capable of simultaneously demodulating.

Further, transmission control of the wireless communication apparatuses may be performed by the group as a unit.

Further, transmission control may be performed based on intra-group IDs that are allocated to the wireless communication apparatuses in the group.

Further, the present invention provides a wireless communication system in which plural wireless communication apparatuses simultaneously transmit data to a wireless base station and which performs control such that at least two of the plural wireless communication apparatuses do not simultaneously transmit a channel estimation signal.

Another aspect of the present invention provides a wireless communication method in a first wireless communication apparatus that is used in a wireless communication system in which plural wireless communication apparatuses simultaneously transmit data to a wireless base station apparatus, the wireless communication method including a step of performing control such that a channel estimation signal is not transmitted in a case where a second wireless communication apparatus transmits the channel estimation signal.

Further, the present invention provides a wireless communication method in a first wireless base station apparatus that is used in a wireless communication system in which plural wireless communication apparatuses simultaneously transmit data to a wireless base station, the wireless communication method including a step of performing control such that at least two of the plural wireless communication apparatuses that simultaneously transmit data do not simultaneously transmit a channel estimation signal.

This specification includes the contents disclosed in the specification and/or the drawings of Japanese Patent Application No. 2012-231917, upon which the priority of this application is based.

### Advantageous Effects of Invention

The present invention enables reduction in errors in channel state information.

### BRIEF DESCRIPTION OF DRAWINGS

FIG. 1 is a diagram that illustrates an outline of a case where transmission requests occur in the order of an STA1, an STA2, and an STA3.

FIG. 2 is a diagram that illustrates an outline of a protocol that is used in this embodiment.

FIG. 3 is a diagram that illustrates one configuration example of a wireless communication system according to a first embodiment of the present invention.

FIG. 4 is a diagram that illustrates a configuration example of a data packet to be transmitted.

FIG. 5 is a function block diagram that illustrates one configuration example of an AP.

FIG. 6 is a function block diagram that illustrates one configuration example of an STA.

FIG. 7 is a flowchart that illustrates a flow of a process.

FIG. 8 is a diagram that, by using a timing diagram, illustrates one example of a case where the AP performs communication with two STAs and communication is performed from the STA1 to the AP and from the STA2 to the AP immediately after that.

FIG. 9 is a diagram that illustrates one example of allocation of group IDs and intra-group IDs.

### DESCRIPTION OF EMBODIMENTS

A wireless communication technology according to embodiments of the present invention will hereinafter be described in detail with reference to drawings.

### First Embodiment

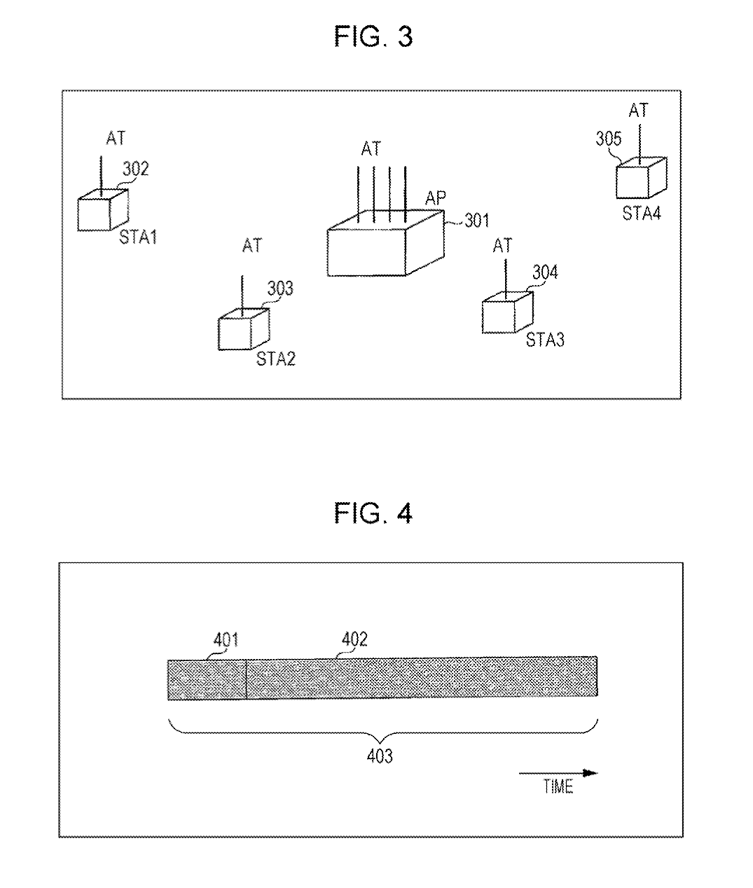

FIG. 3 is a diagram that illustrates one configuration example of a wireless communication system according to a first embodiment of the present invention. As illustrated in FIG. 3, the wireless communication system is configured with one access point (hereinafter referred to as “AP”) 301 and plural terminal apparatuses (hereinafter referred to as “STA”) 302 to 305. In FIG. 3, the number of STAs is four, but the number of STAs may be any number as long as that is two or more. It is assumed that the STAs 302 to 305 perform communication only with the AP 301 and communication among the plural STAs is not performed. The AP 301 includes plural antennas AT and includes four receive antennas and one transmit antenna in this embodiment. The STA includes one antenna for both of transmission and reception.

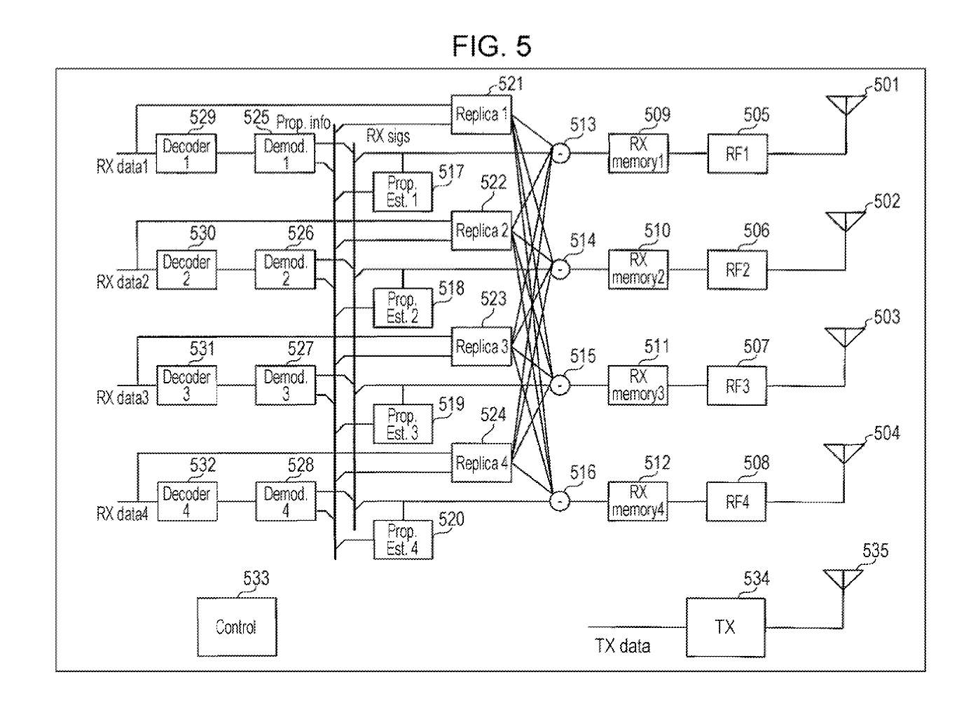

FIG. 5 is a function block diagram that illustrates one configuration example of an AP. The reference numerals 501 to 504 denote receive antennas that receive RF signals. The reference numerals 505 to 508 denote RF units that convert the RF signals into baseband signals and perform A/D conversion. The reference numerals 509 to 512 denote receive signal storage units (RX memory) that may store the baseband signals that correspond to a prescribed period and extract receive signals that correspond to an arbitrary time in a stored period. The reference numerals 513 to 516 denote replica subtraction units that subtract replicas output from outputs of replica generation units, which will be described below, from outputs of the receive signal storage units. The reference numerals 517 to 520 denote channel estimation units (Prop.Est) that obtain channel state information from the preambles contained in the receive signals. The reference numerals 521 to 524 denote the replica generation units (Replica) that generate replicas of the receive signals based on output signals of decoding units and outputs of the channel estimation units 517 to 520. The reference numerals 525 to 528 denote demodulation units (Demod.) that perform demodulation of the receive signals based on outputs of the receive signal storage units 509 to 512 and outputs of the channel estimation units 517 to 520 to extract receive data. The reference numerals 529 to 532 denote decoding units that perform a decoding process of error correction codes for outputs of the demodulation units. The reference numeral 533 denotes a control unit (Control) that monitors states of the units and performs control. The reference numeral 534 denotes a transmit unit (TX) that performs a coding process by the error correction codes for the transmit data, converts modulated signals into the RF signals, and outputs those to a transmit antenna. The reference numeral 535 denotes the transmit antenna for transmitting the RF signals.

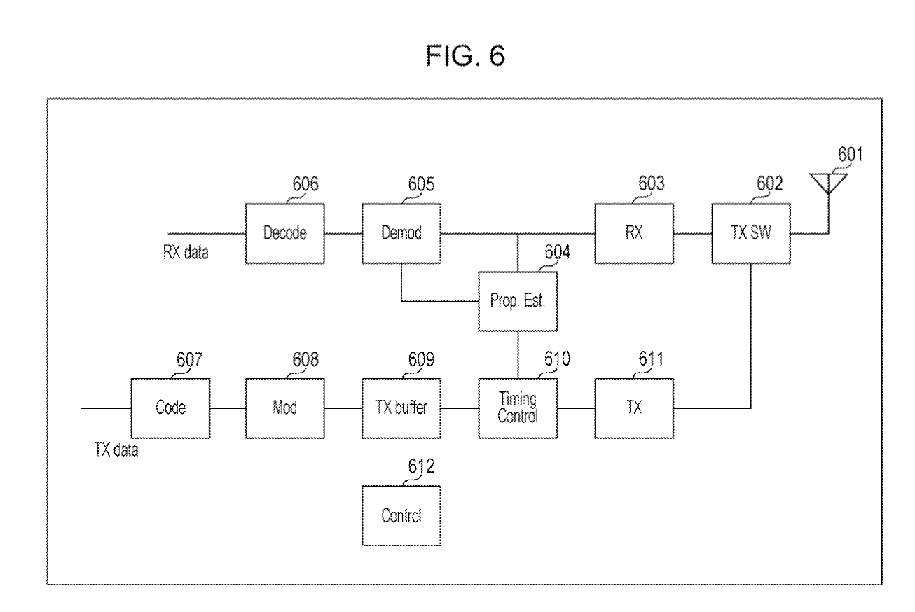

FIG. 6 is a function block diagram that illustrates one configuration example of the STA. The reference numeral 601 denotes an antenna for transmitting and receiving the RF signals. The reference numeral 602 denotes a transmit switch unit (TX SW) that switches antenna connection destinations to either one of a receive unit and a transmit unit. The reference numeral 603 denotes the receive unit (RX) that receives the RF signals, converts those into the baseband, and performs A/D conversion. The reference numeral 604 denotes a channel estimation unit (Prop.EstX) that detects the preamble from the receive signal to obtain the channel state information. The reference numeral 605 denotes a demodulation unit (Demod.) that demodulates the receive signal by using the channel state information. The reference numeral 606 denotes a decoding unit (Decoder) that decodes the error correction codes that are applied to demodulated signals to extract the receive data. The reference numeral 607 denotes a coding unit (Code) that performs a coding process by the error correction codes for the transmit data. The reference numeral 608 denotes a modulation unit (Mod) that modulates an output of the coding unit. The reference numeral 609 denotes a transmit buffer unit (TX buffer) that accumulates modulated data and outputs the modulated data at a timing when those are necessary. The reference numeral 610 denotes a timing control unit (Timing Control) that controls transmission start timings. The reference numeral 611 denotes a transmit unit (TX) that converts input modulated data into the baseband signals by D/A conversion, further converts the baseband signals into the RF signals, and outputs those. The reference numeral 612 denotes a control unit (Control) that monitors states of the units and performs control.

Various modulation schemes may be used by the AP and the STAs. In this embodiment, it is assumed that a common scheme is used by the AP and the STAs. As one example, it is possible to use an OFDM scheme that is used in wireless LANs.

The AP and the STAs transmit a code that is known by the AP and the STAs as a channel estimation signal so that the receiving side may estimate the channel state information prior to transmission of data. The outline of this is illustrated in FIG. 4. As illustrated in FIG. 4, a preamble 401 that is configured with a known code is arranged in the head portion of a data packet 403 to be transmitted, and a data portion 402 is arranged next thereto.

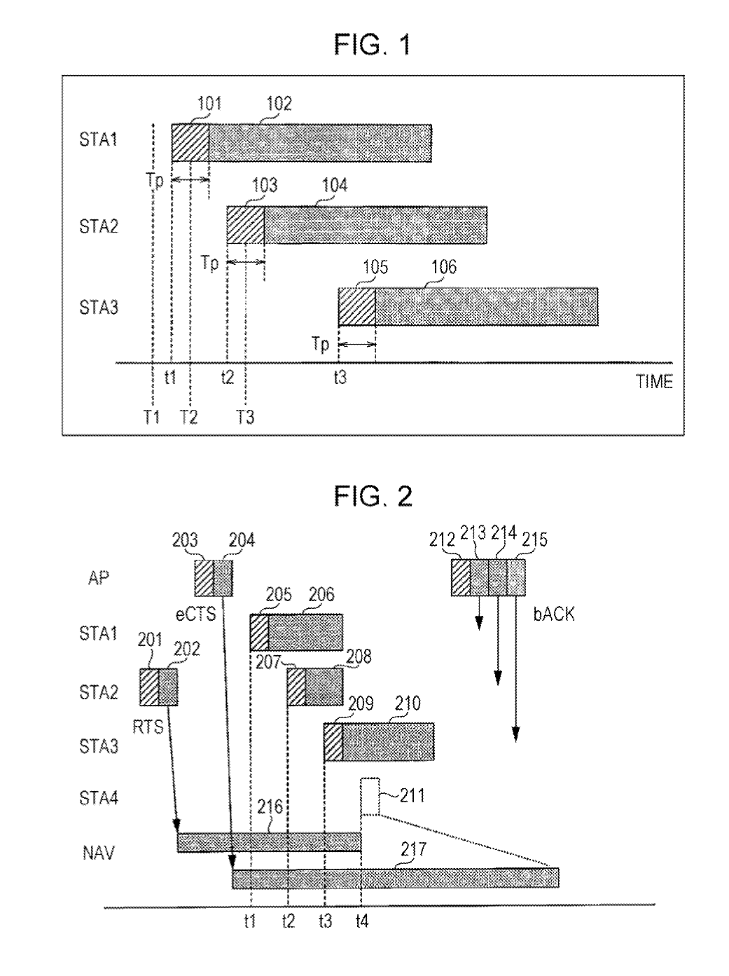

A description will next be made about a procedure in which the three STAs (STA1, STA2, and STA3) sequentially transmit data to the AP. An outline of a case where transmission requests occur in the order of the STA1, the STA2, and the STA3 is illustrated in FIG. 1. As illustrated in FIG. 1, respective timings when the transmission requests occur in the STAs are denoted by T1, T2, and T3.

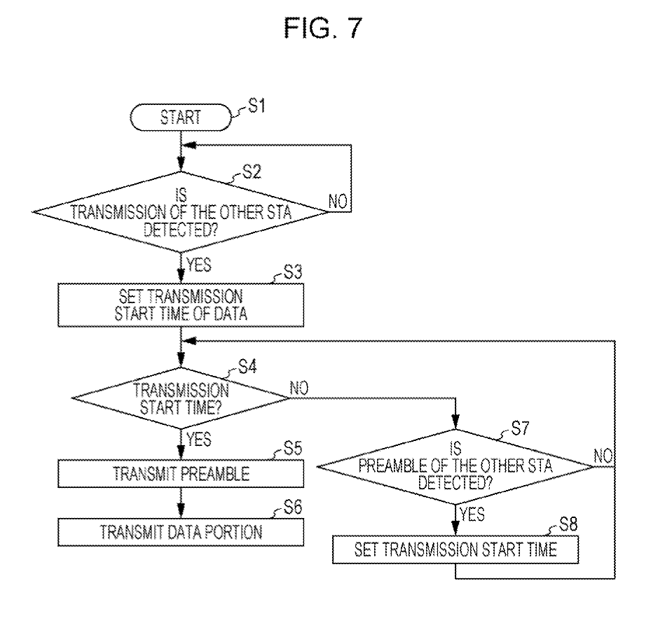

FIG. 7 is a flowchart that illustrates a flow of a process. The process starts (step S1). First, in step S2, the STA1 in which the first transmission request occurs confirms that the other STAs are not performing transmission and starts transmission of a preamble 101 and a data portion 102 (steps S5 and S6). This transmission start time is set as t1 (step S3). When the STA2 detects that the other STA (STA1) starts transmission (step S4), the STA2 immediately detects whether the preamble is transmitted. Various methods may be used for the detection method of the preamble. As one example, a method may be used in which a determination is made that the preamble is detected in a case where the correlation between the known code used in transmission and the receive signal is calculated and a correlation value higher than a prescribed value is obtained.

The STA2 sets a transmission start time t2 to a time after T2 when the transmission request occurs. However, t2 is set so that t2−t1 is longer than a time Tp that is necessary for transmission of the preamble. The STA2 transmits a preamble 103 when the time becomes t2 and next transmits a data portion 104. In a case where transmission of the preamble of the other STA is detected in the period until t2 (step S7), t2 is again set to a time after transmission of the preamble whose transmission start time is detected finishes (step S8). The STA3 immediately detects whether the preamble is transmitted, similarly to the STA2, when the STA3 detects that the other STA starts transmission. The preamble 101 transmitted from STA1 and the preamble 103 transmitted from the STA2 are detected. Thus, a time t3 when transmission is started after T3 when the transmission request occurs in the STA3 is set to a time after the time when the transmission of the preamble 103 transmitted from the STA2 finishes. That is, the time t3 is set so that t3−t2 is longer than Tp.

The STAs operate as described above. Accordingly, transmission of the preambles and data portions from the respective STAs is performed at the timings illustrated in FIG. 1.

A case where the STA3 may not detect the preamble 103 that comes from the STA2 occurs depending on the relationship between the received power of the signal that comes from the STA1 and the received power of the signal that comes from the STA2. In such a case, to lower the possibility of collision between the preamble transmitted from the STA2 and the preamble transmitted from the STA3, a method may be used such as setting Tp or a time after a prescribed time that is Tp or longer multiplied by a prescribed random number (natural number) elapses as the transmission start time, after the preamble is detected when the transmission start time is set.

A description will next be made about an operation in a case where the AP demodulates the signals transmitted at the timings illustrated in FIG. 1. The AP 301 converts the signals that are received by the receive antennas 501 to 504 into digital signals in the baseband by the receive units 505 to 508 and accumulates the signals in the receive signal storage units 509 to 512. The receive signal storage units 509 to 512 are so-called ring buffers and may store receive information that corresponds to a prescribed period and extract the receive information that corresponds to an arbitrary time from the storage period. Old information is overwritten by new receive information. The receive signal storage units 509 to 512 output the receive information to the replica subtraction units 513 to 516 while storing the receive information.

Because there is no output from the replica generation units 521 to 524 in a case where the signal is not received from any of the STAs, the replica subtraction units 513 to 516 output input signals while applying no change. The channel estimation units 517 to 520 perform detection of the preambles contained in the outputs of the replica subtraction units 513 to 516 and perform channel estimations of channels between the receive antennas 501 to 504 and the transmitting STAB.

The signals from the STA (STA1) that performs transmission first are demodulated by using the demodulation unit 525. The signals output from the replica subtraction units 513 to 516 are demodulated based on the channel state information obtained by the channel estimation units 517 to 520. Various demodulation methods may be used. As one example, maximum likelihood (ML) estimation is used that estimates the signal with the highest possibility of being transmitted based on the receive signals. The error correction codes of the signals demodulated by the demodulation unit 525 are decoded by the decoding unit 529, and the receive data are extracted. The extracted receive data are input to the replica generation unit 521. Further, the channel state information from the transmitting STA (STA1) to the receive antennas 501 to 504, which is estimated by the respective channel estimation units 517 to 520, is also input to the replica generation unit 521. The replica generation unit 521 generates replicas of the signals received by the receive antennas 501 to 504 based on the input receive data and the channel state information.

Demodulation of the signals transmitted from the STA2 is next performed. After demodulation and decoding of the signals transmitted from the STA1 are successful and generation of the replicas finishes, the control unit 533 controls the receive signal storage units 509 to 512 to again extract the receive data of the signals transmitted from the STA1, which correspond to the time after a receive start time. The replicas are simultaneously extracted from the replica generation unit 521 and are input to the replica subtraction units 513 to 516. Accordingly, the outputs of the replica subtraction units become signals in which transmit signals of the STA1 are removed from the receive signals. The channel estimation units 517 to 520 detect the preamble from the signals resulting from removal of the transmit signals of the STA1. Because the transmit signals are as illustrated in FIG. 1, this preamble is the one transmitted from the STA2. The channel estimation units 517 to 520 use the detected preamble to estimate the channel state information between the STA2 and the receive antennas 501 to 504. The demodulation unit 526 next demodulates the output signals of the replica subtraction units 513 to 516 by using the channel state information. The decoding unit 530 decodes the error correction codes of the demodulated signals, and the receive data are extracted. The extracted receive data are input to the replica generation unit 522. Further, the channel state information from the STA2 to the receive antennas 501 to 504, which is estimated by the respective channel estimation units 517 to 520, is input to the replica generation unit 522. The replica generation unit 522 generates replicas of the signals received by the receive antennas 501 to 504 based on the input receive data and the channel state information.

Demodulation of the signals transmitted from the STA3 is next performed. After demodulation and decoding of the signals transmitted from the STA2 are successful and generation of the replicas finishes, the control unit 533 controls the receive signal storage units 509 to 512 to again extract the receive data of the signals transmitted from the STA2, which correspond to the time after the receive start time. The replicas are simultaneously extracted from the replica generation units 521 and 522 and are input to the replica subtraction units 513 to 516. It is assumed that data to be extracted from the replica generation unit 521 is extracted from a portion of the signals transmitted from the STA2, which corresponds to the receive start time. Accordingly, the outputs of the replica subtraction units become signals in which the transmit signals of the STA1 and the STA2 are removed from the receive signals.

The channel estimation units 517 to 520 detect the preamble from the signals resulting from removal of the transmit signals of the STA1 and the STA2. Because the transmit signals are as illustrated in FIG. 1, this preamble is the one transmitted from the STA3. The channel estimation units 517 to 520 use the detected preamble to estimate the channel state information between the STA3 and the receive antennas 501 to 504. The demodulation unit 527 next demodulates the output signals of the replica subtraction units 513 to 516 by using the channel state information. The decoding unit 531 decodes the error correction codes of the demodulated signals, and the receive data are extracted. The extracted receive data are input to the replica generation unit 523. Further, the channel state information from the STA3 to the receive antennas 501 to 504, which is estimated by the respective channel estimation units 517 to 520, is input to the replica generation unit 523. The replica generation unit 523 generates replicas of the signals received by the receive antennas 501 to 504 based on the input receive data and the channel state information.

The AP operates as described above to perform demodulation of the signals illustrated in FIG. 1. The AP operates in a similar manner in a case where the other STA starts transmission after the transmission of the STA3 or the STA1 again starts transmission after finishing transmission and may thereby perform demodulation of the signals.

Accordingly, demodulation and decoding of the receive signals are enabled by not allowing the preambles to be simultaneously transmitted in a case where the plural STAs use the same preambles and perform transmission in an overlapped manner.

### Second Embodiment

In this embodiment, one example will be described where a protocol used in wireless LANs is expanded to control the transmission start timings of plural STAs and control is thereby performed so that the preambles are not simultaneously transmitted.

Although several protocols are suggested for wireless LANs, a representative scheme may be the distributed coordination function (DCF) protocol that is used in IEEE 802.11.

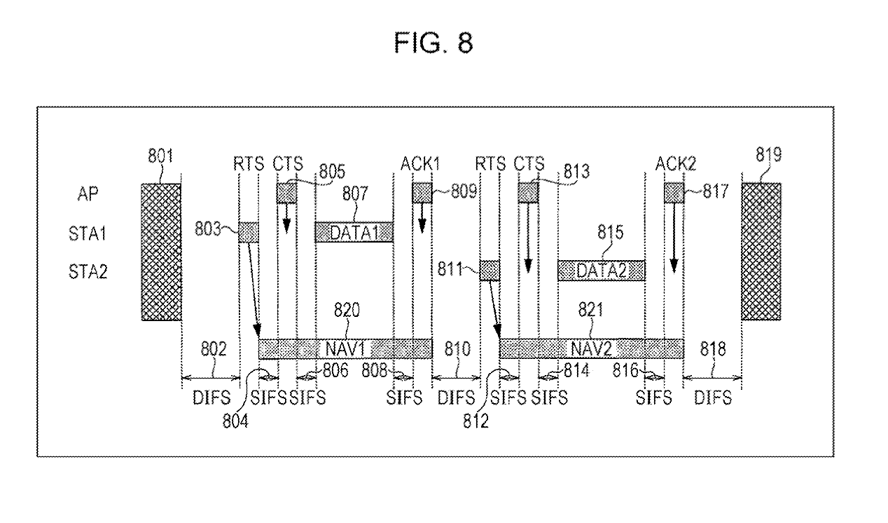

One example of communication by using this DCF will be described with reference to FIG. 8. FIG. 8 illustrates, by using a timing diagram, one example of a case where the AP performs communication with two STAs and communication is performed from the STA1 to the AP and from the STA2 to the AP immediately after that. The STA1 first waits until transmission 801 of the AP or any of the STAs finishes. After finish of transmission, the STA1 further waits for a distributed coordination function interframe space (DIFS) time 802 and transmits request to send (RTS) 803 to the AP. The DIFS is a waiting time for the distributed coordination function (DCF). A longer basic time than an SIFS, which will be described below, is set for the DIFS, and a random backoff time is further added thereto.

A network allocation vector (NAV) (NAV1 820) is set in transmission of the RTS 803 so that the other STAs do not perform transmission for a prescribed time after the transmission of the RTS 803. The NAV is also referred to as transmission prohibition time. A time necessary for transmission of clear to send (CTS), transmission of data, and further transmission of acknowledge (ACK; also referred to as acknowledgment) to the CTS and data are set as the NAV. The other STAs that receive the NAV are prohibited from transmission for the set time. In a case where the AP may normally receive the RTS 803, the AP waits for a short interframe space (SIFS) time 804 while assuming that any STA does not use wireless resources and transmits CTS 805 to the STA1. The SIFS is a minimum specified time for the STA to perform transmission and is a time that is specified so that the other STAs or the like do not interrupt when an important packet such as the CTS is transmitted.

A longer time than this SIFS is specified for the DIFS or the like for starting DCF access, thereby enabling preferential transmission of an important packet. The AP also sets the NAV in transmission of the CTS 805. The value resulting from the subtraction of the time necessary for transmission and reception of the RTS 803 from the time set for the RTS 803, that is, a substantially same value as the value set for the RTS 803 is set for the NAV that is set by the AP. Accordingly, a substantially same NAV may be obtained for the STA that may not receive the RTS. Next, the STA1 that receives the CTS 805 assumes itself to be authorized for transmission, waits for a SIFS time 806, and thereafter transmits DATA1 807 to the AP. The AP that receives the DATA1 807 waits for a SIFS time 808 and transmits ACK1 809 to the STA1. The STA1 that receives ACK1 determines that transmission of the DATA1 807 is completed and subsequently performs no transmission. The STA2 waits for the time of the NAV1 820 and receives communication between the STA1 and the AP, waits for a DIFS time 810 after the timing when all the transmission finishes, and transmits RTS 811 to the AP.

In the transmission of the RTS 811, a time necessary for transmission of the CTS, transmission of data, and further transmission of the ACK for the CTS and data is set as a NAV2 821. In a case where the AP may normally receive the RTS 811, the AP waits for a SIFS time 812 while assuming that any STA does not use wireless resources and transmits CTS 813 to the STA2. In the transmission of the CTS 813, the time that is needed for reception of the RTS 811 is subtracted similarly to the above, and a time that is substantially equivalent to the NAV2 821 is set as the NAV. The STA2 that receives the CTS 813 assumes itself to be authorized for transmission, waits for a SIFS time 814, and thereafter transmits DATA2 815 to the AP. The AP that normally receives the DATA2 815 waits for a SIFS time 816 and transmits ACK2 817 to the STA2. The STA2 that receives ACK2 817 determines that transmission is completed and subsequently performs no transmission. Then, another DCF access 819 is enabled after a DIFS time 818 elapses.

In this DCF, one STA obtains a transmission opportunity by one exchange of the CTS and the RTS. However, in this embodiment, an expansion is made so that plural STAs obtain a transmission opportunity by one exchange of the CTS and the RTS.

It is assumed that the configurations of the AP and the STAs used in this embodiment are similar configurations to the first embodiment.

An outline of a protocol that is used in this embodiment is illustrated in FIG. 2. A group ID and an intra-group ID other than a unique address are allocated to the STA at a point when the STA establishes connection (association) with the AP. It is assumed that STA1 to STA4 are allocated to the same group. The intra-group ID of 0 is allocated to the STA1, 1 to the STA2, 2 to the STA3, and 3 to the STA4.

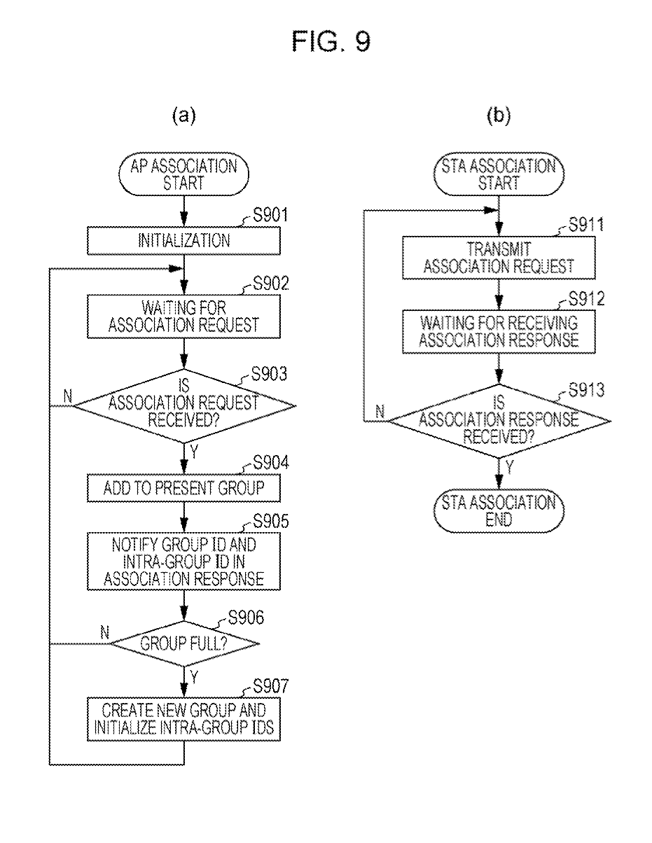

One example of allocation of the group IDs and the intra-group IDs will be described with reference to FIG. 9. It is assumed that the upper limit of the STAs that may be added to each group is a prescribed value, for example, four. This number depends on the configuration of the AP and is the value that does not exceed the number of the STAs that may be simultaneously demodulated by the AP.

FIG. 9(a) is a flowchart that illustrates an operation of the AP side. First, the group IDs and the intra-group IDs that are used in S901 that is a state where any STA is not connected are initialized. Here, the initial value of 0 is used for both of those. After the initialization, the AP waits until a connection request (association request) is transmitted from the STA in S902. In S903, a determination is made whether the connection request is received. The process returns to S902 in a case where the connection request is not received and progresses to S904 in a case where the connection request is received. The STA that transmits the connection request in S904 is registered in the present group ID as the present intra-group ID. In S905, the group ID and the intra-group ID that are registered are notified to the STA that transmits the connection request when a connection response (association response) is transmitted. In S906, one intra-group ID is increased, and a determination is made whether the intra-group IDs reach the upper limit of addition to the group. The process returns to S902 in a case where the upper limit is not reached and progresses to S907 in a case where the upper limit is reached. In S907, a new group in which one group ID is increased is created, and the intra-group IDs are initialized, thereby enabling addition of the STA to the new group. The process then returns to S902.

A connection request procedure of the STA will next be described with reference to FIG. 9(b). In S911, the connection request is transmitted to the AP. In S912, the STA waits until the connection response is received. The group ID and the intra-group ID are notified when the connection response is received. Thus, the STA registers those IDs as the IDs of itself in the STA. In S913, it is assumed that the connection request is failed in a case where the connection response is not received, and the process returns to S911. The connection process finishes in a case where the connection response is received. The AP and the STAs operate as described above, and the allocation of group IDs and intra-group IDs is thereby performed.

In the above procedure, the group IDs and the intra-group IDs are allocated in the order of the connection requests. However, the AP may measure the received power by the channel estimation unit when the STA receives the connection request and configure the group such that there are prescribed differences among the received power from the STAs included in the group. In this case, if the group is configured such that the received power of the STA with the intra-group ID of the smaller number becomes higher, demodulation is sequentially performed from the STA with the higher received power when the AP and the STAs operate while following a procedure which will be described below. This increases the possibility of demodulation success.

A transmission procedure illustrated in FIG. 2 will hereinafter be described. The STA2 in the group transmits an RTS packet to the AP. A data portion 202 that contains the RTS packet is transmitted following a preamble 201 in transmission. The AP that receives the RTS packet transmits expanded CTS (eCTS) to the group after a prescribed time, for example, the SIFS time elapses. In the DCF in related art, the address of the STA that transmits the RTS is specified as the transmission destination in CTS transmission. However, in this embodiment, the group ID is specified as the transmission destination in transmission of the expanded CTS. A data portion 204 that contains the expanded CTS is transmitted following a preamble 203 in transmission of the expanded CTS. The STAs included in the group IDs that are specified by the extended CTS (which correspond to the STA1 to the STA4 here) start transmission sequentially from the STAs with the smaller intra-group IDs at prescribed time intervals after a prescribed time, for example, the SIFS time elapses. In a transmission start instruction, transmission of data portions 206, 208, and 210 start following transmission of preambles 205, 207, and 209. The prescribed time interval may be an arbitrary time as long as transmission periods of the preambles do not overlap with each other. FIG. 2 illustrates a case where transmission intervals t1 to t2, t2 to t3, and t3 to t4 are regular intervals. The STA that has no transmission data may not perform transmission of data at the transmission start time. FIG. 2 illustrates a case where the STA4 has no transmission data and transmission of the preamble is not performed at a preamble transmission start time 211.

After reception of all the data finishes, the AP transmits the ACKs to the STAs after a prescribed time, for example, the SIFS time elapses. Following a preamble 212, ACK 213 for the STA1, ACK 214 for the STA2, and ACK 215 for the STA3 are successively transmitted. The respective STAs that receive the ACKs 213 to 215 recognize that communication is completed by reception of the ACKs.

Setting of the NAV in the above procedure will be described. The NAV that is set when the STA2 transmits the RTS is a time that is needed until the RTS is transmitted, thereafter the CTS is received, data is transmitted, and the ACK for the transmitted data is received, as in related art. The NAV that is set when the AP transmits the expanded CTS is a time that is needed until all the STAs included in the group transmit a prescribed length, for example, 1500 octets of data and the ACKs are thereafter transmitted to all the STAs. In FIG. 2, the NAV on the assumption that the STA4 performing no transmission would perform transmission is set. This avoids overlapped transmission of the preambles due to transmission started by the STAs in another group until the STAs included in the group finish transmission.

All the transmitted preambles are controlled not to overlap with each other by using the above communication procedure. Thus, the AP performs a similar operation to the one described in the first embodiment and may thereby demodulate all the data.

Further, in the above embodiments, the configurations and so forth illustrated in the attached drawings are not limited to those but may appropriately be modified within the scope where the effects of the present invention may be obtained. In addition, the present invention may be practiced with appropriate modifications without departing from the object of the present invention. Further, the elements of the present invention may arbitrarily be selected, and inventions that include the selected configurations are included in the present invention.

Further, a program for realizing functions that are described in the embodiments is recorded in a computer-readable recording medium, the program that is recorded in the recording medium is read and executed by a computer system, and a process of each unit may thereby be performed. It should be noted that the “computer system” herein includes an OS and hardware such as peripheral devices.

Further, the “computer system” includes a homepage providing environment (display environment) in a case where the WWW system is used.

Further, “computer-readable recording media” are portable media such as flexible disks, magneto-optical disks, ROMs, and CD-ROMs and storage devices such as hard disks that are built in the computer system. In addition, the “computer-readable recording media” include elements that dynamically retain the program for a short period of time like communication wires in a case where the program is transmitted via a communication line such as a network like the Internet and a telephone line and elements that retain the program for a certain period such as volatile memories in the computer systems that are servers or clients in the above case. Further, the program may realize a portion of the above-described functions and may be realized in combination with a program where the above-described functions are already recorded in the computer system. At least a portion of the functions may be realized by hardware such an integrated circuit.

In the present invention, control is performed so that transmission timings of channel estimation codes (preambles) that are transmitted from plural communication apparatuses are mutually different.

The present invention provides a first wireless communication apparatus that is used in a wireless communication system in which plural wireless communication apparatuses simultaneously transmit data to a wireless base station apparatus, the first wireless communication apparatus including a transmission timing control unit that performs control such that a channel estimation signal is not transmitted in a case where a second wireless communication apparatus transmits the channel estimation signal.

This enables reduction in errors in channel state information.

The transmission timing control unit may perform control such that transmission of the channel estimation signal is performed in a case where the second wireless communication apparatus transmits data following transmission of the channel estimation signal.

The present invention provides a wireless base station apparatus that is used in a wireless communication system in which plural wireless communication apparatuses simultaneously transmit data to a wireless base station, the wireless base station apparatus including a control unit that performs control such that at least two of the plural wireless communication apparatuses that simultaneously transmit data do not simultaneously transmit a channel estimation signal.

After transmission of data starts after a first communication apparatus transmits the channel estimation signal, one of communication apparatuses that are different from the first communication apparatus may be caused to start transmission of the channel estimation signal.

Further, the wireless communication apparatuses may be split into plural groups, and group allocation may be performed such that the number of the wireless communication apparatuses that are included in the group does not exceed the number of data that the wireless base station apparatus is capable of simultaneously demodulating.

Further, transmission control of the wireless communication apparatuses may be performed by the group as a unit.

Further, transmission control may be performed based on intra-group IDs that are allocated to the wireless communication apparatuses in the group.

Further, the present invention provides a wireless communication system in which plural wireless communication apparatuses simultaneously transmit data to a wireless base station and which performs control such that at least two of the plural wireless communication apparatuses do not simultaneously transmit a channel estimation signal.

Another aspect of the present invention provides a wireless communication method in a first wireless communication apparatus that is used in a wireless communication system in which plural wireless communication apparatuses simultaneously transmit data to a wireless base station apparatus, the wireless communication method including a step of performing control such that a channel estimation signal is not transmitted in a case where a second wireless communication apparatus transmits the channel estimation signal.

Further, the present invention provides a wireless communication method in a first wireless base station apparatus that is used in a wireless communication system in which plural wireless communication apparatuses simultaneously transmit data to a wireless base station, the wireless communication method including a step of performing control such that at least two of the plural wireless communication apparatuses that simultaneously transmit data do not simultaneously transmit a channel estimation signal.

### INDUSTRIAL APPLICABILITY

The present invention is usable for a wireless communication apparatus.

### REFERENCE SIGNS LIST

301 AP
302 to 305 STA
501 to 504 receive antenna
505 to 508 RF unit
509 to 512 receive signal storage unit (RX memory)
513 to 516 replica subtraction unit
517 to 520 channel estimation unit (Prop.Est)
521 to 524 replica generation unit (Replica)
525 to 528 demodulation unit (Demod.)
529 to 532 decoding unit
533 control unit (Control)
534 transmit unit (TX)
535 transmit antenna
601 antenna
602 transmit switch unit (TX SW)
603 receive unit (RX)
604 channel estimation unit (Prop.EstX)
605 demodulation unit (Demod.)
606 decoding unit (Decoder)
607 coding unit (Code)
608 modulation unit (Mod)
609 transmit buffer unit (TX buffer)
610 timing control unit (Timing Control)
611 transmit unit (TX)
612 control unit (Control)

All publications, patents, and patent applications cited herein are incorporated herein by reference in their entirety.

1. A first wireless communication apparatus that is used in a wireless communication system in which plural wireless communication apparatuses simultaneously transmit data to a wireless base station apparatus, the first wireless communication apparatus comprising:
a transmission timing control unit that performs control such that a channel estimation signal is not transmitted in a case where a second wireless communication apparatus transmits the channel estimation signal.

2. The first wireless communication apparatus according to claim 1,
wherein the transmission timing control unit performs control such that transmission of the channel estimation signal is performed in a case where the second wireless communication apparatus transmits data following transmission of the channel estimation signal.

3. A wireless base station apparatus that is used in a wireless communication system in which plural wireless communication apparatuses simultaneously transmit data to a wireless base station apparatus, the wireless base station apparatus comprising:
a control unit that performs control such that at least two of the plural wireless communication apparatuses that simultaneously transmit data do not simultaneously transmit a channel estimation signal.

4. The wireless base station apparatus according to claim 3,
wherein after transmission of data starts after a first wireless communication apparatus transmits the channel estimation signal,
one of the wireless communication apparatuses that are different from the first wireless communication apparatus is caused to start transmission of the channel estimation signal.

5. The wireless base station apparatus according to claim 3, wherein the wireless communication apparatuses are split into plural groups, and
group allocation is performed such that the number of the wireless communication apparatuses that are included in the group does not exceed the number of data that the wireless base station apparatus is capable of simultaneously demodulating.

6. The wireless base station apparatus according to claim 4,
wherein the wireless communication apparatuses are split into plural groups, and
group allocation is performed such that the number of the wireless communication apparatuses that are included in the group does not exceed the number of data that the wireless base station apparatus is capable of simultaneously demodulating.
